(19) United States
(12) Patent Application Publication
(10) Pub. No.: US 2005/0141134 A1
(43) Pub. Date: Jun. 30, 2005

(54) System and method for disk formatting

(75) Inventor: Maxim Roth, Cupertino, CA (US)

Correspondence Address: FLIESLER MEYER, LLP, FOUR EMBARCADERO CENTER, SUITE 400, SAN FRANCISCO, CA, 94111, US

(73) Assignee: Matsushita Electric Industrial Co., Ltd., Kadoma-shi (JP)

(21) Appl. No.: 11/014,329

(22) Filed: Dec. 16, 2004

Related U.S. Application Data
(60) Provisional application No. 60/532,473, filed on Dec. 24, 2003.
(60) Provisional application No. 60/532,479, filed on Dec. 24, 2003.

(51) Int. Cl. G11B 5/55; G11B 5/02

(52) U.S. Cl. 360/97.01; 360/55; 360/265.9

(57) ABSTRACT

The gap of a write head on an arm of a rotating media storage device is positioned at an angle off perpendicular from an arm chord, which is a line defined from the center of the gap to the center of the pivot of the arm. This increases the skew for a written field on a disk. This increased skew can narrow the tracks and/or allow the use of a wider, less expensive write head.

### CLAIMS OR PRIORITY

This application claims priority to U.S. Provisional Application No. 60/532,473 entitled “Disk Formatting” filed Dec. 24, 2003 and U.S. Provisional Application No. 60/532,479 entitled “Method for Disk Formatting” filed Dec. 24, 2003.

### FIELD OF THE INVENTION

The invention relates to rotating media storage devices such as hard disk drives.

### BACKGROUND

Rotating media storage devices are an integral part of computers and other devices with needs for large amounts of reliable memory. Rotating Media Storage Devices are inexpensive, relatively easy to manufacture, forgiving where manufacturing flaws are present, and capable of storing large amounts of information in relatively small spaces.

A typical rotating media storage device includes a head disk assembly and electronics to control operation of the head disk assembly. The head disk assembly can include one or more disks. The disks include a recording surface to receive and store user information. For hard disk drives, the recording surface can be constructed of a substrate of metal, ceramic, glass or plastic with a thin magnetizable layer on either side of the substrate. Data is transferred to and from the recording surface via a head mounted on an actuator assembly. Heads can include one or more read and/or write elements, or read/write elements, for reading and/or writing data. Drives can include one or more heads for reading and/or writing. In magnetic disk drives, heads can include a thin film inductive write element and a magneto-resistive read element.

Hard disk drives can operate in one of more modes of operations. In a first mode or operation, often referred to as seek or seeking, a head moves from its current location, across a disk surface to a selected track. In a second mode, often referred to as track following, a head is positioned over a selected track for reading data from a track or writing data to a track.

In order to move a head to a selected track or to position a head over selected tracks for writing and reading, servo control electronics are used. In some disk drives, one disk can be dedicated to servo. The servo disk can have embedded servo patterns that are read by a head. Heads for data disks can be coupled to the servo disk head to be accurately positioned over selected tracks. In other disk drives, servo information can be embedded within tracks on the medium at regular intervals. Servo information is read as a head passes over a track to accurately position the head relative to a track.

While servo positioning circuitry is generally accurate, heads can drift from desired locations during track following operations. Reading or writing data with inaccurate head positioning can have adverse affects on drive performance.

In modern disk drives, tracks are placed increasingly closer together to increase data storage capacity. Narrower tracks are often used in order to increase the tracks per inch (TPI) on a disk. Measures should be used in drives to ensure that reliability and performance are maintained as data storage capacity increases.

### BRIEF SUMMARY

Systems and devices in accordance with embodiments of the present invention use a write head with a gap that is at a non-perpendicular angle with respect to a line defined between the pivot of the actuator assembly and the center of the gap (arm chord). This can increase the skew angle and thus narrow the track size for a given write head width.

Other features, aspects, and objects of the invention can be obtained from a review of the specification, the figures, and the claims.

### BRIEF DESCRIPTION OF THE DRAWINGS

FIG. 1 is a diagram showing components of an exemplary rotating media storage device that can be used in accordance with one embodiment of the present invention.

FIG. 2 is a top view of a rotatable storage medium that can be used in the drive of FIG. 1.

FIG. 3 is an illustration of a servo sector of a track on a disk of a rotating media storage device.

FIG. 4 is an example of a prior art actuator arm.

FIG. 5 illustrates the use of the prior art actuator arm on a disk of a rotating media storage device.

FIG. 6A and 6B illustrate an actuator arm of one embodiment of the present invention.

FIG. 7 illustrates tracks produced using a actuator arm of the present invention.

FIG. 8 illustrates the use of the actuator arm on a disk.

FIG. 9 illustrates using alignment offsets with a method of the present invention.

### DETAILED DESCRIPTION

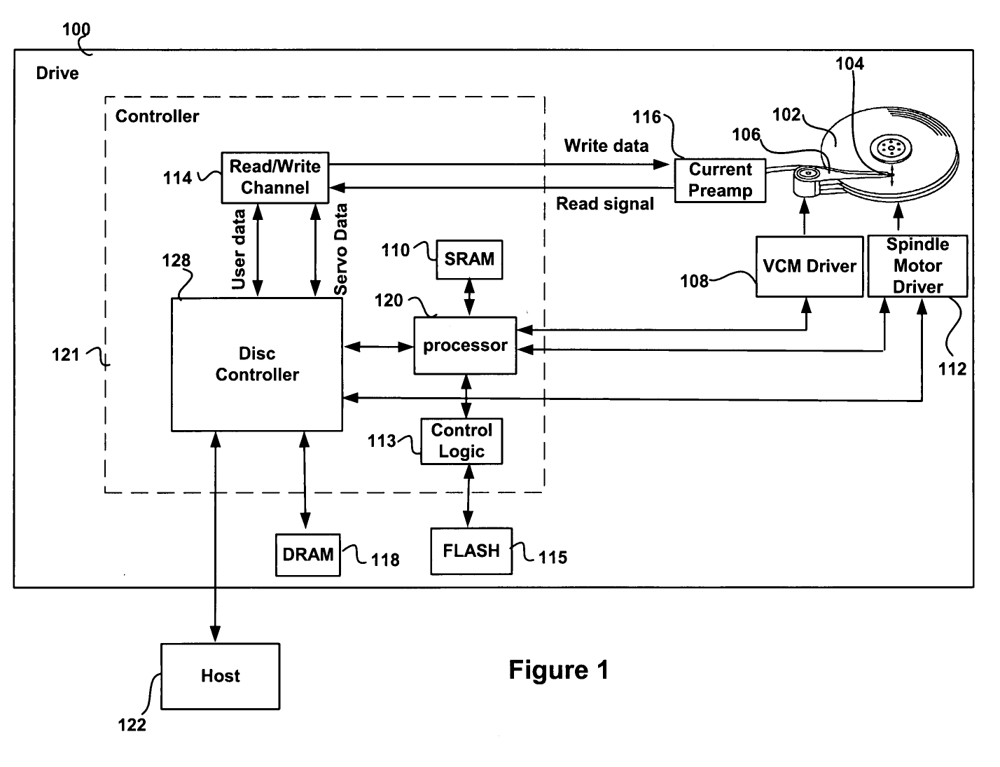

FIG. 1 shows a rotating media storage device 100 that can be used in accordance with one embodiment of the present invention. In this example, the rotating media storage device 100 is a hard disk drive. The rotating media storage device 100 includes at least one rotatable storage medium 102 capable of storing information on at least one surface. Numbers of disks and surfaces may vary by disk drive. In a magnetic disk drive, storage medium 102 is a magnetic disk. A closed loop servo system, including an actuator arm 106, can be used to position head 104 over selected tracks of disk 102 for reading or writing, or to move head 104 to a selected track during a seek operation. In one embodiment, head 104 is a magnetic transducer adapted to read data from and write data to the disk 102. In another embodiment, head 104 includes separate read elements and write elements. The read element can be a magnetoresistive (MR) head. Multiple head configurations may be used.

The servo system can include an actuator unit 108, which may include a voice coil motor driver to drive a voice coil motor (VCM) for rotating of the actuator arm 106. The servo system can also include a spindle motor driver 112 to drive a spindle motor (not shown) for rotation of the disk 102. Controller 121 can be used to control the rotating media storage device 100. The controller 121 can include a number of arrangements. In one embodiment, the controller includes a disk controller 128, read/write channel 114, processor 120, SRAM 110, and control logic 113 on one chip. These elements can also be arranged on multiple chips. The controller can include fewer elements as well.

In one embodiment, the controller 121 is used to control the VCM driver 108 and spindle motor driver 112, to accept information from a host 122 and to control many disk functions. A host can be any device, apparatus, or system capable of utilizing the data storage device, such as a personal computer or Web server. The controller 121 can include an interface controller in some embodiments for communicating with a host and in other embodiments, a separate interface controller can be used. The controller 121 can also include a servo controller, which can exist as circuitry within the drive or as an algorithm resident in the controller 121, or as a combination thereof. In other embodiments, an independent servo controller can be used.

Disk controller 128 can provide user data to a read/write channel 114, which can send signals to a current amplifier or pre-amp 116 to be written to the disk(s) 102, and can send servo signals to the microprocessor 120. Controller 121 can also include a memory controller to interface with memory such as the DRAM 118 and FLASH memory 115. FLASH memory 115 can be used as non-volatile memory to store a code image. DRAM 118 can be used as a buffer memory and to store the code to be executed along with the SRAM 110.

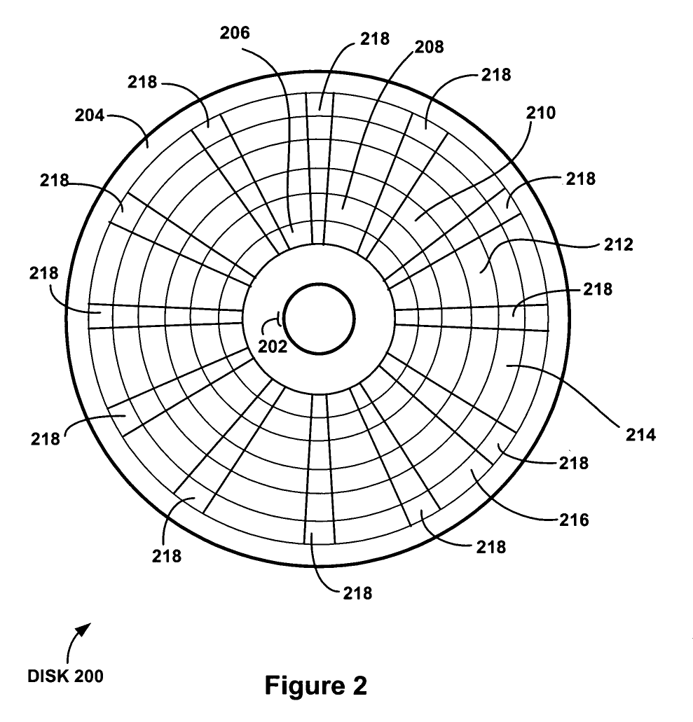

The information stored on a disk can be written in concentric tracks. FIG. 2 is a top view of an exemplary rotatable storage disk 200. A multiple of concentric tracks extend from near an inner diameter (ID) 202 of the disk 200 to near an outer diameter (OD) 204. These tracks may be arranged within multiple data zones 206-216, extending from the ID 202 to the OD 204. Data zones can be used to optimize storage within the data storage tracks because the length of a track in inner data zone 206 may be shorter than the length of a track at outer zone 216. While eight zones are shown in FIG. 2, any number of zones may be used. For example, sixteen zones are used in one embodiment. Disk 200 includes multiple servo sectors 218, also referred to as servo wedges. In this example, servo sectors 218 are equally spaced about the circumference of storage disk 200.

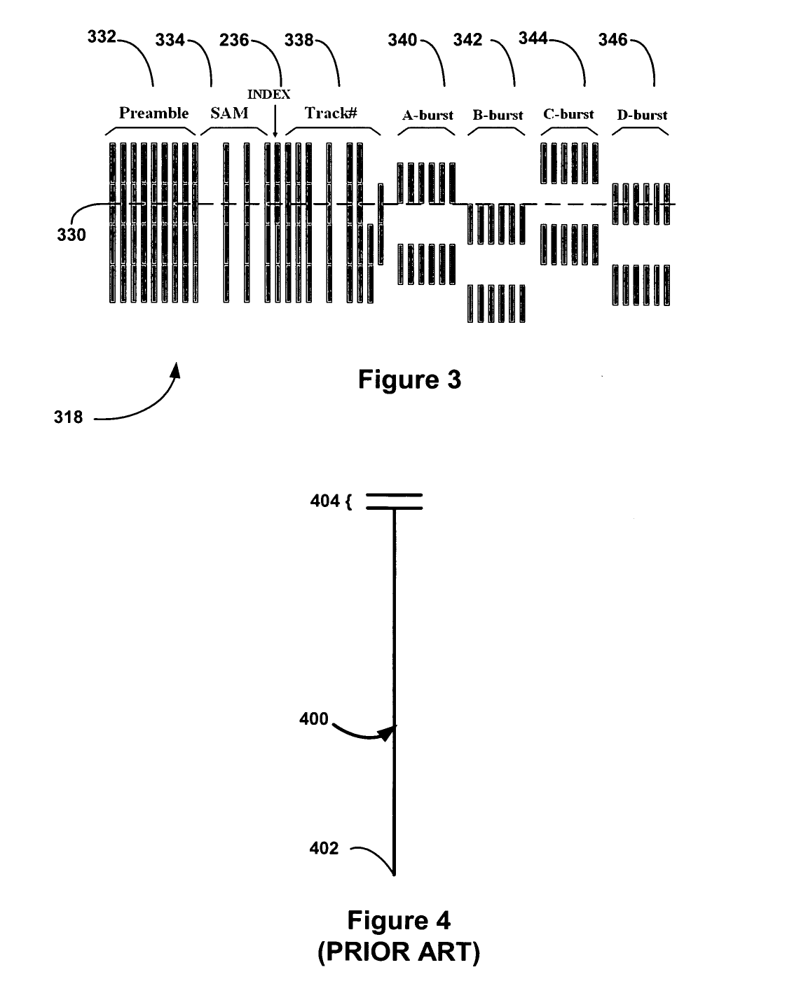

An exemplary servo sector 318 is illustrated in FIG. 3. The servo information shown includes a preamble 332, a servo address mark (“SAM”) 334, an index 336, a track number 338, and servo bursts 340-346. These fields are exemplary, as other fields may be used in addition to, or in place of, the exemplary fields, and the order in which the fields occur may vary. The preamble 332 can be a series of magnetic transitions which can represent the start of the servo sector 318. In the servo sector of FIG. 3, the SAM 334 specifies the beginning of available information from the servo sector 318. The track number 238, usually gray coded, is used for uniquely identifying each track. Servo bursts 340-346 are positioned regularly about each track, such that when a data head reads the servo information, a relative position of the head can be determined that can be used by a servo processor to adjust the position of the head relative to the track. This relative position can be determined by looking at the PES value of the appropriate bursts. The PES, or position error signal, is a signal representing the position of a head or element relative to a track centerline.

FIG. 3 shows prior art longitudinally encoded bursts. A centerline 330 for a given data track can be “defined” by a series of bursts, burst edges, or burst boundaries, such as a burst boundary defined by the lower edge of A-burst 340 and the upper edge of B-burst 342. For example, if a read head evenly straddles an A-burst and a B-burst, or portions thereof, then servo demodulation circuitry in communication with the head can produce equal amplitude measurements for the two bursts, as the portion of the signal coming from the A-burst above the centerline is approximately equal in amplitude to the portion coming from the B-burst below the centerline. The resulting computed PES can be zero if the radial location defined by the A-burst/B-burst (A/B) combination, or A/B boundary, is the center of a data track, or a track centerline. In such an embodiment, the radial location at which the PES value is zero can be referred to as a null-point. Null-points can be used in each servo wedge to define a relative position of a track. If the head is too far toward the outer diameter of the disk, or above the centerline in FIG. 3, then there will be a greater contribution from the A-burst that results in a more “negative” PES. Using the negative PES, the servo controller could direct the voice coil motor to move the head toward the inner diameter of the disk and closer to its desired position relative to the centerline. This can be done for each set of burst edges defining the shape of that track about the disk.

FIG. 4 illustrates a prior art actuator arm. The actuator arm includes a pivot 402 about which the actuator arm rotates. The actuator arm also includes a write head having a gap 404. The gap 404 is perpendicular to a line defined between the pivot 402 and the gap 404.

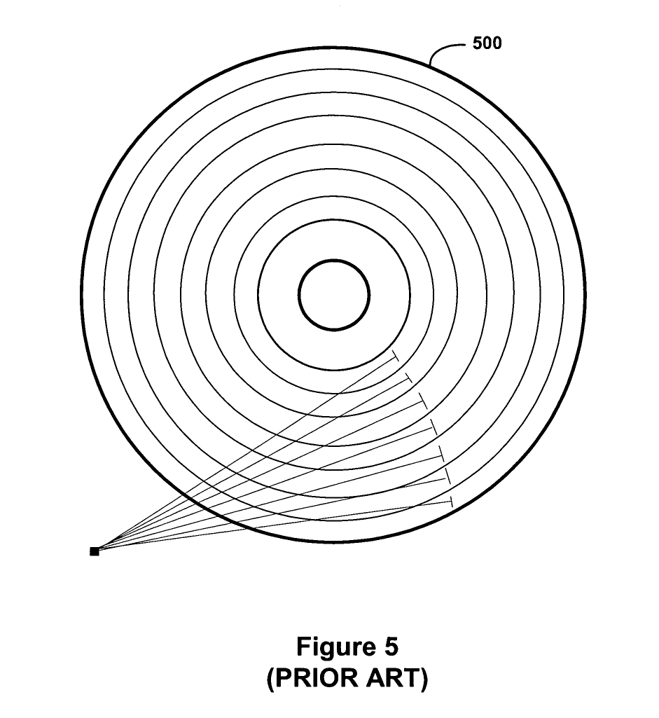

FIG. 5 shows an advantage of the actuator arm of FIG. 4. When the actuator is at adjacent track positions, the fields written by the write head onto the disk 500 for a given disk position align. The alignment of the written fields is especially important for servo writing.

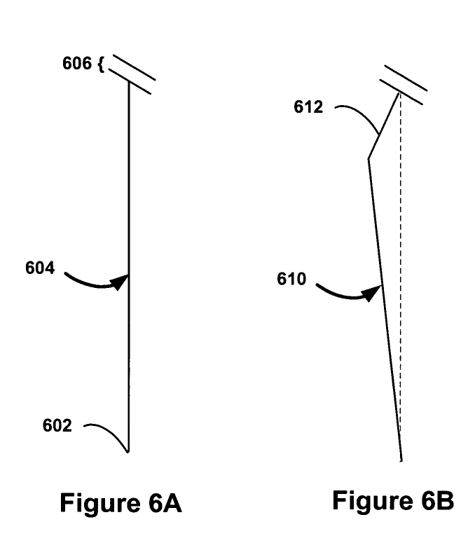

FIG. 6A and 6B illustrate embodiments of the present invention. FIG. 6A shows, an actuator arm including a pivot 602. The pivot can be a conventional pivot used in actuator assemblies. An arm portion 604 is operably connected to the pivot. The arm portion can include a suspension and/or other structures. A write head with a gap 606 is operably connected to the arm. The write head can be positioned on a slider (not shown). The gap 606 has an angle that is non-perpendicular to a line defined from the center of the gap to the center of the pivot. Such a non-perpendicular angle can increase the skew of fields written with the actuator arm.

In one embodiment, the angle is greater than 1 degree off of the perpendicular. In another embodiment the angle is greater than 5 degrees off the perpendicular. Yet in another embodiment the angle is greater than 10 degrees off of the perpendicular.

In some embodiments, the actuator assembly includes a separate read head. The read head can be orientated at the angle of the write head. In one embodiment, the read head is a MR read head with a MR strip orientated at the angle.

FIG. 6A illustrates a straight arm 604. FIG. 6B shows a bent arm 610. The bent arm 610 includes a section 612 of the arm adjacent to the write head that is perpendicular to the gap in the write head 606. The bent arm 610 can allow the use of a conventional slider design.

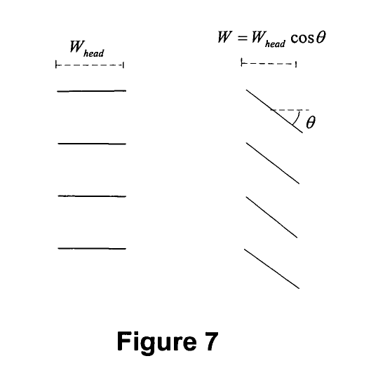

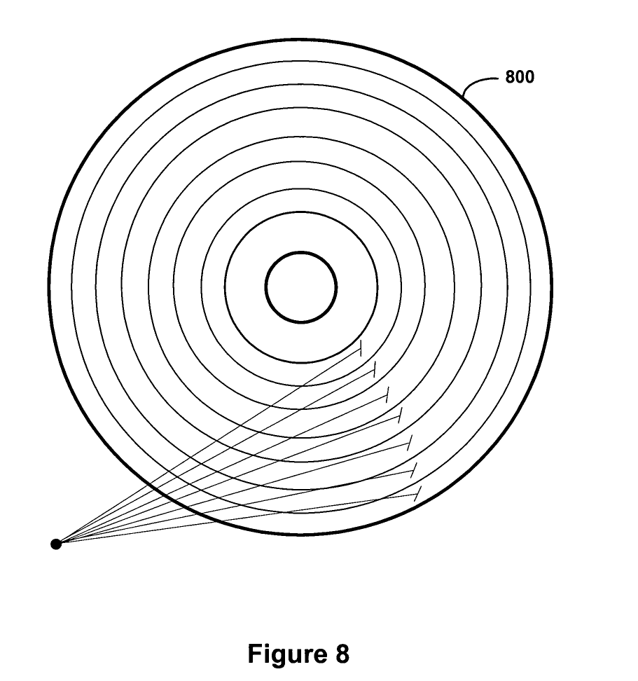

FIG. 7 is a diagram that illustrates an advantage of one embodiment of the present invention. When there is no skew in the written tracks the width of the tracks written is roughly the width of the write head. When the skew is provided by using a skewed write head gap, the width is reduced. In one example the width reduces to W=W_{head} cos θ.

The use of the additional skew angle allows a relatively wide write head to be used. Wider write heads are cheaper than narrow write heads.

Since the magnetizable material of the disk has granular magnetic domains, the sharpness of the transition between written fields may depend upon the length of the edge that interacts with the magnetic domains. By using a write head gap with an angle from the perpendicular, the edge length is increased thus potentially increasing the sharpness of the transition.

For conventional arms, the skew angle (yaw angle) with respect to the written circular track can be calculated for each track by knowing the arm pivot to write gap length (PG), the arm pivot to the spindle distance (PS) and the radius of the track. This angle is: α=sin⁻¹{(rᵢ²+PG²−PS²)/(2*rᵢ*PG)}. Because the write gap is not perpendicular to the tangent to the track, the written track will have a width of WW_{effective}=WW*cos(α), where WW is the magnetic write width. As it can be seen from the equation, as the skew angle gets larger, the effective written track gets narrower.

As shown in the example of FIG. 8, using a write head gap that is not perpendicular to a line defined from the pivot to the gap can increase the skew. If the angle off of the perpendicular is β, the total skew αₜₒₜₐₗ=β+sin⁻¹{(rᵢ²+PG²−PS²)/(2*rᵢ*PG)}. The output voltage of Magnetoresistive (MR) and Giant Magnetoresistive (GMR) heads is a function of flux entering the reader and is independent of the magnetic transition velocity as passes under the reader. As the skew angle gets larger, the media velocity component, perpendicular to the reader gets smaller which will affect inductive heads but not MR. If the track is written with a skew angle, the effective track width is narrower and is a function of the skew angle. If we impose an additional angle β to force the total skew to be “Large” we can effectively make many “narrow” tracks. If a constant guard band approach is used, the number of tracks recorded on the media for a given recording band can be increased. Another advantage is that wider heads can be used to accomplish a high track density because the track width is defined by the projection of the gap length which is narrower than the actual gap length. Additionally, wider guard bands at locations of bad Track Misregistration (TMR) without affecting the track density.

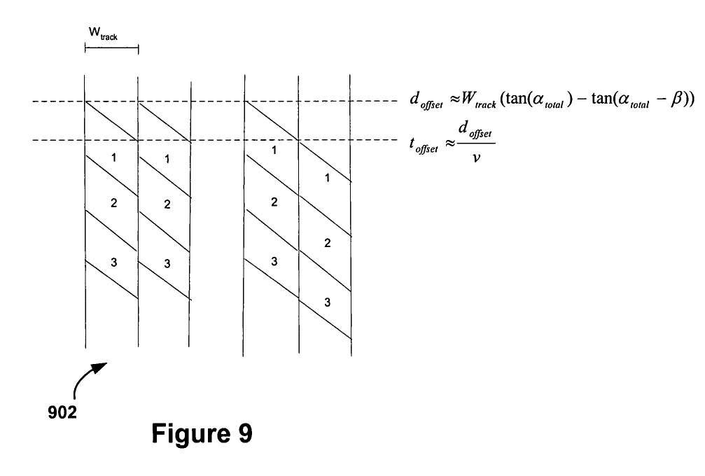

FIG. 8 illustrates the use of an arm having a non-perpendicular gap with the disk 800. The range of skew at the disk for a perpendicular write head gap can ranges from 20 to 20 degrees. By adding an additional skew factor, the skew at the disk is increased thus the track widths are narrowed. FIG. 8 also illustrates that the added skew angle, β, causes a misalignment between written fields at different radii or tracks. Servo Fields of adjacent tracks do not align. FIG. 9 illustrates adjacent tracks written with a write gap having skew angle β. One way to align the fields is to use an alignment offset value. A distance offset d, such as d=W_{track}(Tan(αₜₒₜₐₗ)−Tan(αₜₒₜₐₗ−β)), is used to align adjacent fields in one example. The distance offset corresponds to timing offset of d/v, where v is the velocity of the head over the disk. The velocity, v depends on the rotation speed of the disk and the radius location of the head. By calculating offset values in the rotating media storage device, adjacent fields can be aligned. This is only important for servo fields. Alignment of data fields is typically not required.

The foregoing description of preferred embodiments of the present invention has been provided for the purposes of illustration and description. It is not intended to be exhaustive or to limit the invention to the precise forms disclosed. Many modifications and variations will be apparent to one of the ordinary skill in the relevant arts. The embodiments were chosen and described in order to best explain the principles of the invention and its partial application, thereby enabling others skilled in the art to understand the invention for various embodiments and with various modifications that are suited to the particular use contemplated. It is intended that the scopes of the invention are defined by the claims and their equivalents.

1. A unit for a rotating media storage device comprising:
a pivot;
an arm operably connected to the pivot;
a write head operably connected to the arm, the write head having a gap oriented at an angle that is non-perpendicular to a line defined from the center of the gap to the center of the pivot.

2. The unit of claim 1, wherein the arm is bent.

3. The unit of claim 1, wherein a section of the arm adjacent to write head is perpendicular to the gap of the write head.

4. The unit of claim 1, wherein the arm is straight.

5. An actuator assembly including the unit of claim 1.

6. The unit of claim 1, wherein the angle is greater than 1 degree off the perpendicular.

7. The unit of claim 1, wherein the angle is greater than 5 degree off the perpendicular.

8. The unit of claim 1, wherein the angle is greater than 10 degree off the perpendicular.

9. The unit of claim 1, wherein a read head is operably connected to the arm.

10. The unit of claim 1, wherein the read head is oriented at the angle.

11. The unit of claim 10, wherein the read head is an MR head with an MR strip oriented at the angle.

12. Rotating media storage device including:
at least one magnetizable disk; and
an actuator assembly for writing data to the at least one magnetizable disk, the actuator assembly including a pivot, an arm operably connected to the pivot, and a write head operably connected to the arm, wherein the write head has a gap oriented at an angle that is non-perpendicular to a line defined from the center of the gap to the center of the pivot.

13. The rotating media storage device of claim 12, wherein the arm is bent.

14. The rotating media storage device of claim 12, wherein a section of the arm adjacent to write head is perpendicular to the gap of the write head.

15. The rotating media storage device of claim 12, wherein the arm is straight.

16. The rotating media storage device of claim 12, wherein the angle is greater than 1 degree off the perpendicular.

17. The rotating media storage device of claim 12, wherein the angle is greater than 5 degree off the perpendicular.

18. The rotating media storage device of claim 12, wherein the angle is greater than 10 degree off the perpendicular.

19. A method of writing servo fields on a disk of a rotating media storage device comprising:
using an actuator assembly to write a first servo field at a first radius position of the disk, the actuator assembly including a write head having a gap oriented at an angle that is non-perpendicular to a line defined from the center of the gap to the center of the pivot;
determining an alignment offset value which results from the non-perpendicular angle and
using the actuator assembly to write a second servo field at a second radius position of the disk, the second servo field placed using the alignment offset value.

20. A method of writing data to a rotating media storage device comprising:
using an actuator assembly to write data to a disk, the actuator assembly including a write head having a gap oriented at an angle that is non-perpendicular to a line defined from the center of the gap to the center of the pivot; and
using the actuator assembly to read the data from the disk.
